(19) United States
(12) Patent Application Publication
(10) Pub. No.: US 2012/0137174 A1
(43) Pub. Date: May 31, 2012

(54) METHOD AND SYSTEM FOR FLEXIBLE AUTOMATED INTERACTIONS

(75) Inventors: Joseph BERKOVITZ, Sudbury, MA (US); Robert SHAVER, Watertown, MA (US)

(73) Assignees: ORACLE INTERNATIONAL CORPORATION, REDWOOD SHORES, CA (US); Art Technology Group, Inc., Cambridge, MA (US)

(21) Appl. No.: 13/367,574

(22) Filed: Feb. 7, 2012

Related U.S. Application Data
(62) Division of application No. 09/919,500, filed on Jul. 31, 2001.

(51) Int. Cl. G06F 11/07; G06F 15/16

(52) U.S. Cl. 714/15; 709/224; 714/E11.023

(57) ABSTRACT

A computer platform provides a method and system for establishing scenarios for interactions between users (both individually and as a group) and a web site or other software application over a network. The interactions are described in terms of events, actions, and conditions, where a single mechanism may be used to describe events, actions, and conditions for both individuals and a group. One portion of a scenario may apply to the group, while another portion applies to individuals. Time elements and branches also can be employed to describe the scenario. The scenario may describe a non-deterministic process, but be modeled as a deterministic state machine for execution.

This is a divisional application of U.S. patent application Ser. No. 09/919,500, filed on Jul. 31, 2011, the disclosure of which is hereby incorporated by reference.

### FIELD

This invention relates to computer systems and, more particularly, to platforms for interactions between users and software applications.

### BACKGROUND OF THE INVENTION

In many contexts, users interact electronically with software applications over a network. For example, many organizations interact with users as they sell or promote products or their organization over a network, such as the WorldWide Web. To assist in establishing a WorldWide Web site, numerous systems currently exist for creating and running web sites. These systems often permit users to receive personalized experiences as they visit the web site, depending on profile attributes of a particular user. These attributes may relate both to characteristics of the user (e.g., gender, age, or income) and the user's prior interactions with the web site (e.g., specific pages viewed or products purchased).

Web servers often can track where individuals have gone on a web site, can modify a user's profile based on the user's activity, and can modify the content that a user sees or the messages that a user receives based on the user's profile.

However, existing systems do not provide a satisfactory mechanism for planning and establishing a series of interactions between users and the web site or for handling interactions from both an individual and a group perspective. Planning and establishing interactions becomes particularly difficult where the interactions may take place over an extended time period or occur over diverse communication channels, such as the WorldWide Web, email, telephones, and wireless devices.

### SUMMARY

According to the present invention, a method and system for establishing interactions between users (both individually and as a group) and a web site (or other network-based software) is provided. A set or series of interactions (a “scenario”) can be created, which may involve multiple user sessions. The system permits a single mechanism to be used to describe events, actions, and conditions for both individuals and a group. One portion of a scenario may apply to the group, while another portion applies to individuals.

A scenario describes a kind of non-deterministic process, in which multiple branches of the scenario can be executed in parallel. At any given time, many users may be participating in the same scenario, either in synchrony as a group or independently of each other. The events, actions, and conditions used to describe the scenario can be extensible. The scenario also can be defined in terms of time, by linking events, actions, and conditions with when they occur (e.g., at a certain time or day, or during a specified period, or after a specified wait). In one embodiment, the scenario is modeled as a deterministic state machine.

### BRIEF DESCRIPTION OF THE DRAWINGS

FIG. 1 is a diagram of a description of a portion of a scenario according to an embodiment of the preset invention.

FIG. 2 is a diagram of a state machine corresponding to the description of the scenario shown in FIG. 1, according to an embodiment of the present invention.

FIG. 3 is a diagram of a description of a portion of a scenario according to an embodiment of the present invention.

FIG. 4 is a diagram of a state machine corresponding to the description of the scenario shown in FIG. 3, according to an embodiment of the present invention.

FIG. 5 is a flow diagram of an embodiment of the present invention.

FIG. 6 is a flow diagram of an embodiment of the present invention.

FIG. 7 is a diagram of a description of a portion of a scenario according to an embodiment of the present invention.

FIG. 8 is a diagram of a description of a portion of a scenario according to an embodiment of the present invention.

### DETAILED DESCRIPTION

A scenario can be analogized to a channel or pipe, through which users flow. In the flow, event elements (or events) generally prevent a user from proceeding further through the scenario until the event occurs. Condition elements generally control which users will proceed further. Action elements generally carry out some action, which typically is relative to the user. The pipe can fork, in which case users flow down multiple branches, until they rejoin at the end of the fork. Different kinds of forks can be used. In a regular fork, the user leaves the fork as soon as he or she reaches the join point at the end of the fork, via one of the paths. In a synchronized fork, the user leaves the fork when he or she has proceeded through each of the paths to arrive at the join point. Alternatively, a fork could require some number (but not necessarily all) of the paths to be completed before the user leaves the fork.

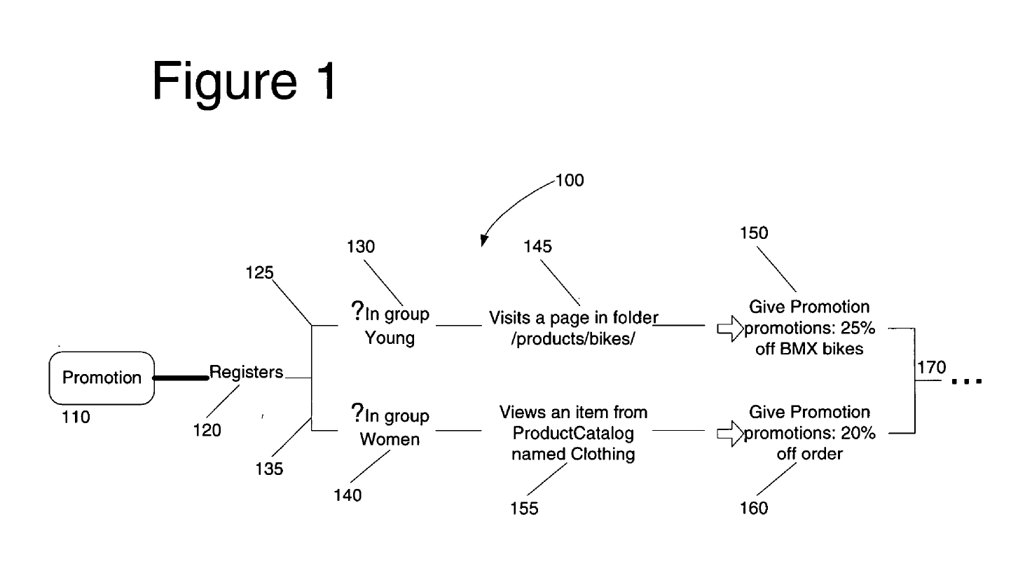

An example portion of a scenario is shown in FIG. 1. Scenario 100 has a name 110 of “Promotion.” Event 120 (“Registers”) corresponds to when a user registers at the web site. A user will not proceed through the scenario until the event occurs, that is, he or she registers. The pipe forks, with two branches. The upper branch 125 has a condition 130 (“In group Young”) and the lower branch 135 has a condition 140 (“In group Women”). These condition elements narrow the set of subjects passing through the pipe, according to definitions provided by the application. Only those users who satisfy the condition can continue down the particular part of the pipe. Thus, only users who meet the definition of “Young” can continue down upper branch 125 and only users who meet the definition of “Women” can continue down lower branch 135. In this case, a young woman would meet both definitions and could continue down both paths. However, the conditions need not allow for a user to continue down multiple paths. Optionally, a fork can include an “Otherwise” element instead of a condition element, so that if the conditions for each of the other branches are not met, the scenario will continue down the “Otherwise” branch. Also, a fork can have multiple (or all) branches without condition elements, so all users proceed down multiple (or all) branches.

Users meeting the “Young” condition 130 continue down upper branch 125, where the scenario waits for event 145 (“Visits a page in folder/products/bikes/”). That is, to continue down this path the user must visit a page that is listed in the bikes folder. Following event 145 is action element 150 (“Give Promotion promotions: 25% off BMX bikes”). Thus, if a user in upper branch 125 visits the specified page from event 145, that user will receive a promotion for 25% off a BMX bike. Users meeting the “Women” condition 140 continue down lower branch 135, where the scenario waits for event 155 (“Views an item from ProductCatalog named Clothing”). That is, to continue down this path the user must view a clothing item from the product catalog. Following event 155 is action element 160 (“Give Promotion promotions: 20% off order”). Thus, if a user in lower branch 135 views the specified item from event 155, that user will receive a promotion for 20% off his or her order.

After action elements 150 and 160, the paths rejoin at point 170, where the scenario could continue with more elements or could end.

If the fork is a regular fork, then once a user reaches the end of any branch (in this example, the user receives promotion 150 or promotion 160), the user exits the fork (at point 170). However, if the fork is a synchronized fork, then the user would not proceed past the exit of the fork until he or she had proceeded to the end of each of the branches. In one embodiment, by default a fork is a regular fork.

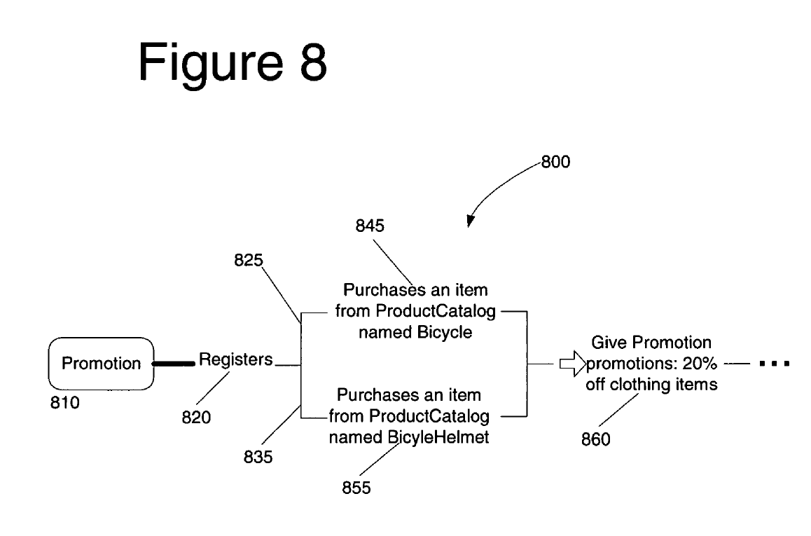

An example of a synchronized fork is shown in FIG. 8. In scenario 800 (with a name 810 of “Promotion”), event 820 (“Registers”) corresponds to when a user registers at the web site. In the upper branch 825, the scenario waits for event 845 (“Purchases an item from ProductCatalog named Bicycle”). In the lower branch 835, the scenario waits for event 855 (“Purchases an item from ProductCatalog named BicycleHelmet”). Because this is a synchronized fork, a user will not exit the fork and reach action element 860 (“Give Promotion promotion: 20% off clothing items”) unless the user purchases an item from both branches of the fork. If scenario 800 did not have a synchronized fork, then the user would exit the fork and receive the promotion once the user reached the end of either branch (in this example, by purchasing either a bicycle or a bicycle helmet).

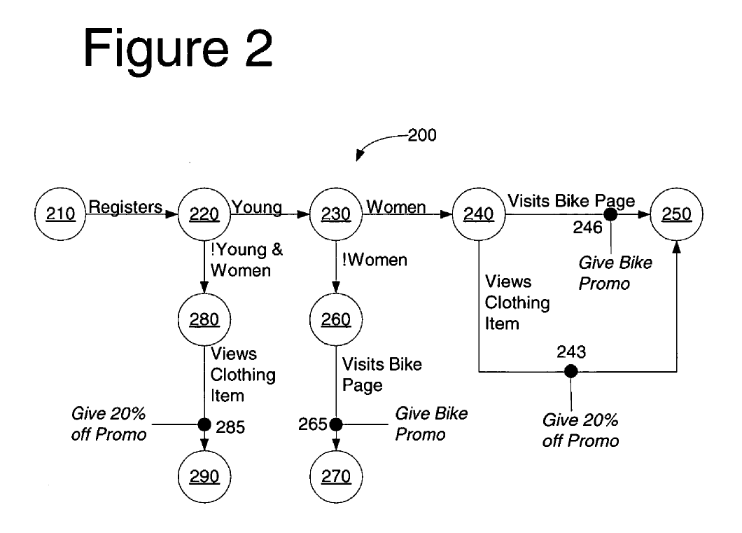

In one embodiment, in order to keep track of where in a scenario the users are, the system uses a state machine, where each user preferably is always in exactly one state and proceeds along a single path through the state machine. A state machine corresponding to the portion of a scenario shown in FIG. 1 (and assuming a regular fork) is shown in FIG. 2. State machine 200 has two kinds of states: waiting states (in this example, states 210, 240, 260, and 280) and intermediate states (in this example, states 220, 230, 250, 270, and 290). Waiting states are states where the scenario execution stops in order to wait for one or more events. Intermediate states are used to channel users to different paths through the state machine. Preferably, the conditions that lead out of an intermediate state are mutually exclusive, so a user proceeds down a single path through the state machine.

In FIG. 2, state 210 corresponds to the beginning of the scenario shown in FIG. 1, before a user registers. By registering, a user proceeds to state 220, an intermediate state through which a user proceeds depending on whether the user is young and/or a woman. If the user is neither young nor a woman, he will not proceed past state 220 in this example. A young user proceeds to intermediate state 230; a user who is not young but is a woman proceeds to state 280. Thus, state 280 corresponds to users who only proceed through the bottom branch in FIG. 1. From state 230, a user who is a woman proceeds to state 240. Users reaching state 240 are young women, and therefore are proceeding through both of the branches in FIG. 1. Users who are not women proceed to state 260, which corresponds to users who only proceed through the top branch in FIG. 1.

From state 240, users who view a listed clothing item (corresponding to event 155) are given the 20% off promotion (at point 243) and proceed to state 250. Users who view a specified bike page (corresponding to event 145) are given the 25% off bike promotion (at point 246) and proceed to state 250.

Similarly, from state 260, users who visit the specified bike page (corresponding to event 145) are given the bike promotion (at point 265) and proceed to state 270. From state 280, users who view a listed clothing item (corresponding to event 155) are given the 20% off promotion (at point 285) and proceed to state 290.

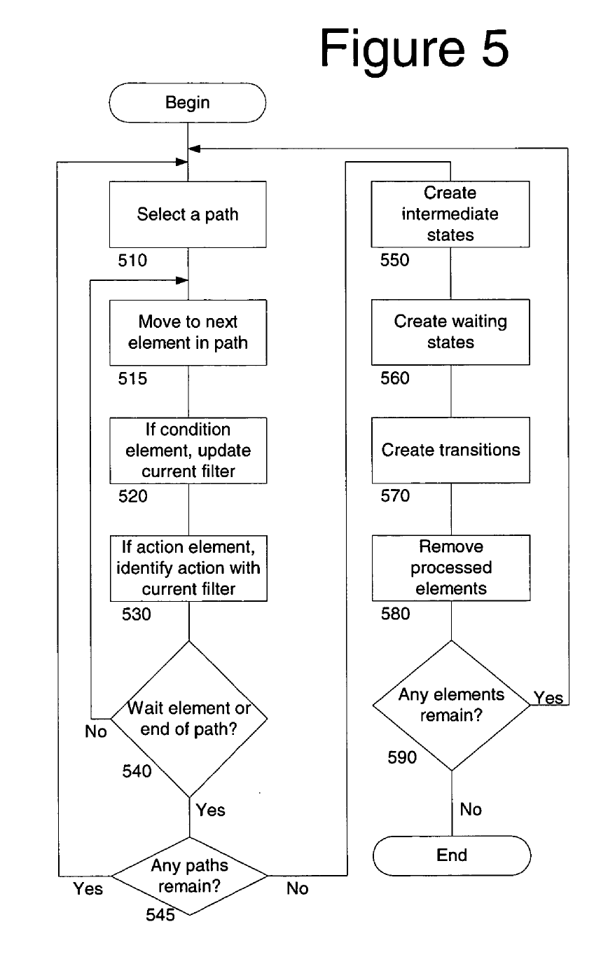

Preferably, a scenario (or, where appropriate, a discrete segment within a scenario) is transformed into a state machine through a looping transformation process, as shown in FIG. 5. At step 510, a path is selected through the scenario. Each time through the loop, the scenario is traversed in a depth-first manner, until all the possible paths through the scenario either complete or encounter a wait element (an event or a time wait). For each path through the scenario, the transformation process moves from one scenario element to the next (steps 515-540). The process keeps track of any conditions that need to be satisfied in order for the user to reach that place in the scenario. When a condition element is encountered (step 520), a filter is augmented by ANDing the condition with the existing filter conditions. When an action element is encountered (step 530), the action is augmented with, or linked to, the current filter, so that the action will be executed only if the filter is satisfied. In addition, the action is added to a list of actions in the transition being constructed. When a path completes or the process encounters a wait element, the process returns to the top of the loop if any paths remain (steps 540 and 545).

When one or more wait elements are reached, one or more new state machine states are created. First, any appropriate intermediate states are created (step 550), to segregate users who are waiting in different paths or combinations of paths through the scenario. Users may wait in different paths or combinations of paths due to encountering the various filter conditions along the paths. Generally, intermediate states will be created if the process encountered more than one wait element. After creating any intermediate states, waiting states are created where the state machine will wait for the events to occur (step 560). In addition, the transformation process creates the corresponding transitions out of each waiting state for each qualifying event (step 570). Once the new waiting states have been created, the transformation process removes the scenario elements prior to and including the wait elements from the scenario (step 580), then loops again as long as the scenario has not been entirely processed (step 590). For a subsequent loop, the transformation process keeps track of the scenario path or combination of scenario paths that is active for each wait state.

Using the example from FIG. 1, the transformation process would involve three passes through the loop. In the first pass, the process encounters the Registers event and therefore creates a waiting state 210, with a transition that waits for the Registers event to occur. The Registers event is then removed from the scenario and the transformation process begins a second pass through the scenario. In upper branch 125 of the fork, the process encounters the “Visits a page” event and can proceed no further. The filter for this event is “In group Young,” the condition that preceded the “Visits a page” event. In lower branch 135, the process gets stopped at the “Views an item” event, with a filter of “In group Women.” At this point, the transformation process creates intermediate states 220 and 230 to handle the different conditions (and reflecting the different paths or combinations of paths in which users may proceed), and waiting states 240, 260, and 280. Waiting states 240, 260, and 280 have transitions based on “Visits a page” event 145 and “Views an item” event 155. Thus, waiting state 260 (for users who are Young and not Women) has a transition based on event 145 for users who visit a specified bike page, and waiting state 280 (for users who are Women and not Young) has a transition based on event 155 for users who view a listed clothing item. Waiting state 240 (for users who are Young and Women) has two transitions, one for each event, and corresponds to users who are active in both branches of the fork.

The elements that have been processed are then removed from the scenario. In the third pass through the loop, the transformation process encounters the action elements in the two branches of the fork, and adds those actions to the state machine transitions. Thus, the 20% off promotion is added (items 243 and 285) to the two transitions based on viewing a clothing item (from states 240 and 280, respectively), and the bike promotion is added (items 246 and 265) to the two transitions based on viewing a specified bike (from states 240 and 260, respectively). The transformation process also adds states 250, 270, and 290 at the ends of the transitions.

Preferably, the state of each user is stored along with the user's profile information in a profile repository. This permits the retrieval of per-user scenario information and allows the state of each user in each scenario to be stored persistently. Thus, the state can be retrieved across multiple user sessions across multiple communication channels, and even if the system must be restarted.

In addition to per-user state, a scenario may have a collective state—that is, a state associated with all of the users or a group of users. Conditions and, in many cases, events and actions can apply both at an individual level and at a collective level. Thus, in general the same condition, event, and action elements can be used in both individual and collective parts of a scenario.

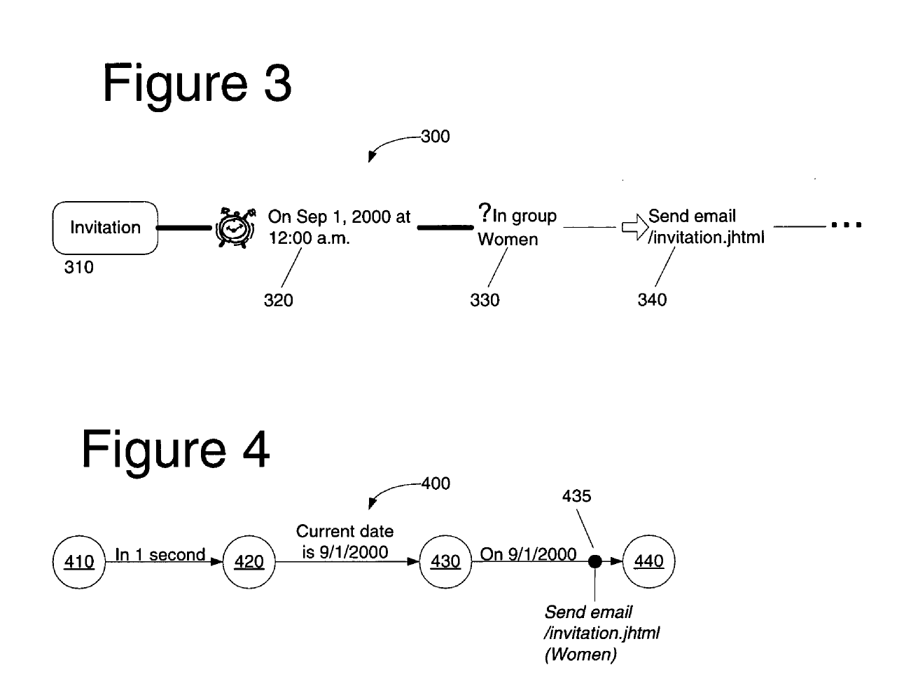

In the example shown in FIGS. 1 and 2, the collective state existed only in state 210, before a user registers. Once a user registers, an individual state for that user preferably is created. Another example of the use of a collective state is shown in FIGS. 3 and 4. FIG. 3 shows a portion of a scenario in which a site's female users receive an email invitation at a specified date and time. Scenario 300 has a name 310 of “Invitation.” At time event 320 (“On Sep. 1, 2000 at 12:00 a.m.”), users who meet condition element 330 (“In group Women”) receive an email via action element 340 (“Send email/invitation.jhtml”).

A state machine corresponding to the portion of the scenario shown in FIG. 3 is shown in FIG. 4. In state machine 400, an initial waiting state 410 has been added, with a transition occurring one second after the scenario begins. This provides a uniform way to start a scenario. Alternatively, other mechanisms could be used to start scenarios. In an alternative embodiment, no initial waiting state or uniform way to start a scenario is employed. Because the time event in this example (“On Sep. 1, 2000 at 12:00 a.m.”) is for a specific time, the state machine includes intermediate state 420 with a condition that the date is before Sep. 1, 2000. Otherwise, the subsequent events will not occur. From intermediate state 420, the state machine proceeds to waiting state 430, where the scenario waits for the specified date. The scenario then sends the specified email (corresponding to action element 340) to women (those who meet condition element 330) at point 435, and proceeds to state 440.

In this example, a collective state is maintained through state 430. Up through state 430, the scenario does not mention or distinguish users at all. After state 430, when the email has been sent to specified (women) users, individual instances of objects are created to hold each user's state as the users proceed through the rest of the scenario. The collective portions of the scenario are represented, in FIGS. 1, 3, and 8, by the thick lines connecting elements (for example, from element 110 to element 120 in FIG. 1, and from element 310 to element 330 in FIG. 3), while the individual portions are represented by thin lines connecting elements (for example, the lines connecting each element after element 120 in FIG. 1).

In part, the use of a collective scenario can provide an optimization. By using a collective scenario, the system does not need to create individual scenario instances for each user. In the example shown in FIGS. 3 and 4, the instances for male users would end up doing nothing. Also, with a collective scenario, the system can delay creating each of the female instances.

Collective instances (objects that hold the collective state) also can make the scenarios work better. For example, the example shown in FIGS. 1 and 2 proceeds once a new user registers. Thus, initially creating individual instances for existing users would not work. Also, collective instances allow more easily for scenarios that apply to anonymous, as well as registered, users.

Collective instances can apply to users in general or to a specific list of users (such as, the users who received a specific email). With a specific list, a user may be removed from the list when an individual instance is created for that user, unless the scenario allows for multiple instances for an individual user. With a collective instance that applies to users in general and in which a user cannot be in the collective instance and have an individual instance, the system can determine which users are not in the collective instance by reviewing the individual instances.

Preferably, when an event occurs in an individual scenario, the system executes each transition action from the current state for which the action's filter is satisfied. After all of the actions are executed, the state machine transitions to a target state.

If the target state is intermediate, the system looks for a condition on an outgoing transition that is satisfied for that instance. If such a filter is found, the system takes the corresponding transition out of the intermediate state. Otherwise, the instance can proceed no further through the state machine.

If the target state is a waiting state, the system looks for an outgoing transition that is triggered by a timer event (such as, “in 1 second”). For each such transition, a persistent timer is created such that, at its completion, it will fire the timer event.

In a preferred embodiment, an event in a collective scenario operates similarly, unless an action requires the creation or evaluation of individual instances to handle the transition. If so, the system preferably aborts the collective transition and creates individual instances, as described below.

At times, transitions may be taken by a batch of individual scenarios at once. Preferably, in such a case, the transitions are carried out in batches. For example, an email may be sent more efficiently to a batch of individuals using a single SMTP connection, rather than opening and closing a new connection for each individual.

In a preferred embodiment, events can be recurring. For example, a user may qualify for a certain promotion each time he or she purchases a certain type of item. Or, once a user purchases a certain item, that user may then qualify for a promotion on the first day of every month. With a recurring event (such as a new promotion on the first day of every month), a new scenario instance is created (by, in effect, cloning the original instance). The new instance handles the transition to a new state, leaving the original instance able to create additional new instances if the event recurs.

Similarly, when an individual instance must be created from a scenario in a collective state, a new individual instance of the scenario may be created, leaving the collective instance able to create further individual instances.

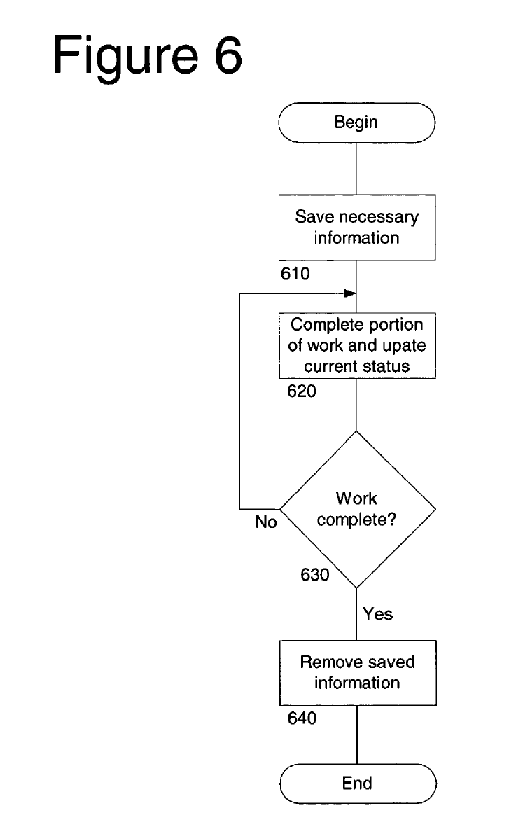

Preferably, an individual event (an event specific to an individual user) is part of a single transaction. If an error occurs while handling the event, the transaction is rolled back, and the affected scenario instance (or instances) revert back to their prior state. However, a global event (an event that applies or potentially applies to all users) may involve too many scenario instances to be handled as a single transaction. Thus, a global event preferably is spread across several transactions. Preferably, these transactions are structured to allow for a recovery in the case where the system goes down in the midst of handling a global event. In a preferred embodiment, as shown in FIG. 6, in a first transaction all of the information necessary to capture the work that needs to be done to handle the global event is saved in the profile repository (step 610). In successive transactions, part of the work is completed and the recorded information is updated to indicate the current status of handling the event (steps 620 and 630). Preferably, this is accomplished by performing the appropriate work on a batch of individual instances in each transaction. In the final transaction, any remaining saved information is removed (step 640). With this structure, if an error occurs while handling the event, the current transaction is rolled back, which affects only the specific individual instances in that batch.

Similarly, if a transition from a collective instance to individual instances will cause a sufficiently large number of individual instances to be created (as, for example, with the scenario described in FIGS. 3 and 4, in which instances are created for all female users), the work is spread over multiple transactions. After the necessary information has been saved in a first transaction, individual instances are created or updated in subsequent transactions.

Generally, time events can be based on a specific time (such as “on Sep. 1, 2000”) or a relative time (such as, “in 1 second,” “next Friday,” or “in 1 month”). The time events can occur just once or can be recurring (such as, “each Monday” or “on the 1.sup.st of each month”). Also, time events can specify a range, such as “between Mar. 1, 2001 and Apr. 1, 2001,” “between Monday and Friday,” or “between 12:00 p.m. and 1:00 p.m.”).

In a preferred embodiment, events are treated as objects, with attributes that can be referenced by other elements. For example, an event such as “visits a page in folder/products/bikes/” may refer to a number of different pages. The particular page visited is an attribute of the event object, and could be referenced by another element. For example, after the event, a subsequent element may be an action to change the user's profile attribute of “last page visited” to the particular page.

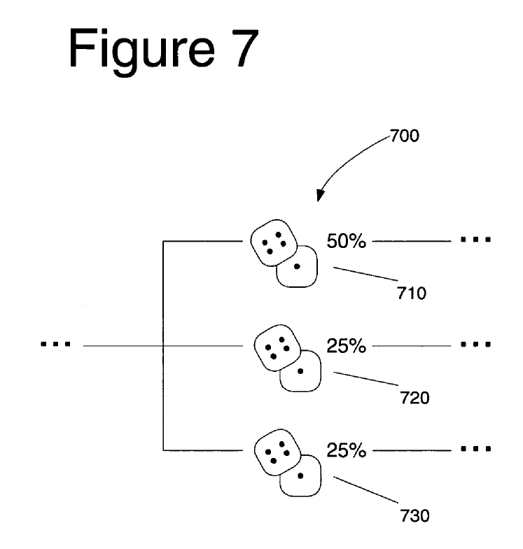

In addition to branching based on particular conditions or events, a branch also can be made using a random number. Preferably, with a random event, the system picks a random number, and the value determines the branch that is taken according to specified percentages. Thus, for example, as shown in FIG. 7, a scenario 700 might have a 3-way branch after the generation of a random number, in which the first branch (element 710) will be taken 50% of the time, the second branch (element 720) will be taken 25% of the time, and the third branch (element 730) will be taken 25% of the time. The different branches may then lead to different emails being sent to the user, different promotions being provided, or any other desired action. A random event can apply both to individual instances and to collective instances. For example, with a collective instance, a random event could be used to select a percentage of the group to receive a specific promotion.

The particular conditions, events, and actions described above are merely exemplary. Conditions generally are based on user profile information, although other information could be used. Events generally are based on user actions (such as visiting a web page, purchasing a particular product, designating a purchased item as a gift, modifying an order, registering with a web site, or logging in or out of a web site), time, or system-based events (such as the system being started or a particular item is out of stock), although any type of event could be used. Actions generally relate to the user (such as, sending an email, providing a promotion, or updating information about the user) but could involve any other action that the system could take. In one embodiment, the set of elements can be extended while the system is running. Alternatively, it may be necessary to restart the system after adding elements.

Preferably, the scenarios system is implemented with computer software. In a preferred embodiment, the software is written in Java, however other software languages could be used. Preferably, the system operates in a cluster of servers. One server operates as a global scenario server and is responsible for starting and stopping the scenarios, and handling global and timer events. The other servers operate as individual scenario servers, with each one being responsible for handling individual events for the users whose sessions it maintains. Optionally, the global server also has user sessions on it and acts also as an individual server. Preferably, to avoid conflicts, only one scenario server is permitted to update a scenario instance (that is, its state) at a time.

The scenarios functionality may be provided as a separate module or integrated as part of an e-business platform, such as the Dynamo suite from Art Technology Group of Cambridge, Mass. The scenarios system may be provided on any suitable storage device, such as a CD-ROM or magnetic disk (hard disk or floppy), or may be transferred electronically (such as over the Internet).

While there have been shown and described examples of the present invention, it will be readily apparent to those skilled in the art that various changes and modifications may be made therein without departing from the scope of the invention as defined by the appended claims. Accordingly, the invention is limited only by the following claims and equivalents thereto.

What is claimed is:

1. A computer readable medium having instructions stored thereon that, when executed by a processor, causes the processor to establishing a plurality of interactions with a web site for a group of users, the instructions comprising:
creating a plurality of states and a plurality of branches to form a scenario for an interaction of each user with the web site, wherein the states comprise a waiting state and an intermediate state, and wherein the waiting state waits for one or more events, and the intermediate state channels the user to different branches of the scenario;
tracking each user along the scenario using a state machine when the user is interacting with the web site;
storing profile information of each user;
storing an individual state of at least one user in the scenario; and
storing a collective state of the users in the scenario.

2. The computer readable medium of claim 1, further comprising:
using the collective state to delay creating a first individual state during the interaction.

3. The computer readable medium of claim 1, further comprising:
using the collective state to avoid creating a first individual state during the interaction.

4. The computer readable medium of claim 1, further comprising rolling back the interaction to a previous event when an error occurs during an event using the stored individual state and the stored collective state.

5. The computer readable medium of claim 1, wherein the user is channeled to a branch based on a random number.

6. The computer readable medium of claim 1, wherein the user is channeled to a branch based on a condition or an event.

7. The computer readable medium of claim 6, wherein the condition is based on user profile information and the event is based on user actions.

8. The computer readable medium of claim 1, wherein an event comprises an object that comprises attributes.

9. The computer readable medium of claim 1, wherein a first user executes multiple branches of the scenario in parallel.

10. A computer implemented method for establishing a plurality of interactions with a web site for a group of users, the method comprising:
creating a plurality of states and a plurality of branches to form a scenario for an interaction of each user with the web site, wherein the states comprise a waiting state and an intermediate state, and wherein the waiting state waits for one or more events, and the intermediate state channels the user to different branches of the scenario;
tracking each user along the scenario using a state machine when the user is interacting with the web site;
storing profile information of each user;
storing an individual state of at least one user in the scenario; and
storing a collective state of the users in the scenario.

11. The method of claim 10, further comprising:
using the collective state to delay creating a first individual state during the interaction.

12. The method of claim 10, further comprising:
using the collective state to avoid creating a first individual state during the interaction.

13. The method of claim 10, further comprising rolling back the interaction to a previous event when an error occurs during an event using the stored individual state and the stored collective state.

14. The method of claim 10, wherein the user is channeled to a branch based on a random number.

15. The method of claim 10, wherein the user is channeled to a branch based on a condition or an event.

16. The method of claim 15, wherein the condition is based on user profile information and the event is based on user actions.

17. The method of claim 10, wherein an event comprises an object that comprises attributes.

18. The method of claim 10, wherein a first user executes multiple branches of the scenario in parallel.

19. A web site server system comprising:
a web site generator;
a scenario generator for the web site to establish a plurality of interactions with the web site for a group of users, the scenario comprising a plurality of states and a plurality of branches, wherein the states comprise a waiting state and an intermediate state, and wherein the waiting state waits for one or more events, and the intermediate state channels the user to different branches of the scenario;
a tracker for tracking each user along the scenario using a state machine when the user is interacting with the web site; and
storage for storing profile information of each user, an individual state of at least one user in the scenario, and a collective state of the users in the scenario.

20. The system of claim 19, wherein the user is channeled to a branch based on a random number.

21. The system of claim 19, wherein the user is channeled to a branch based on a condition or an event.

22. The system of claim 19, wherein the condition is based on user profile information and the event is based on user actions.

23. The system of claim 19, wherein an event comprises an object that comprises attributes.

24. The system of claim 19, wherein a first user executes multiple branches of the scenario in parallel.
